(19) United States
(12) Patent Application Publication
(10) Pub. No.: US 2004/0058611 A1
(43) Pub. Date: Mar. 25, 2004

(54) Non-woven lining for post-dying

(76) Inventors: Marc Deleu, Marcq-En-Baroeul (FR); Jean-Paul Coutant, Neuville-En-Ferrain (FR)

Correspondence Address: BLANK ROME LLP, 600 NEW HAMPSHIRE AVENUE, N.W., WASHINGTON, DC, 20037, US

(21) Appl. No.: 10/285,670

(22) Filed: Nov. 1, 2002

(30) Foreign Application Priority Data
Sep. 25, 2002 (FR) 02 11851

(51) Int. Cl. B32B 5/02; B32B 27/04; B32B 27/12; D04H 1/00; D04H 3/00; D04H 5/00; D04H 13/00; D04H 1/54; D04H 3/14; D04H 5/06

(52) U.S. Cl. 442/409; 442/327; 442/150

(57) ABSTRACT

The object of the invention is a heat-bonding lining of the type comprising a non-woven textile support which is obtained by thermobinding of a web of at least one type of fibre, and a discontinuous layer comprising a hot-melt polymer which is disposed on at least one of the faces of the textile support, in which, in combination, the textile support comprises at least 70% fibres formed from a polymer material based on polyamide and the hot-melt polymer is formed from polyamide.

The invention also concerns a textile complex comprising such a lining as well as a method of manufacturing such a textile complex.

The invention concerns a heat-bonding lining, a textile complex comprising such a lining and a method of manufacturing such a textile complex.

Heat-bonding linings are today normally used in the textile industry, principally as a reinforcement for textiles for clothing. Their application, effected in particular by bonding on a textile layer of the garment, modifies the characteristics of the said layer, in particular its shaping and stabilisation but also its feel, its flexibility and its firmness.

Moreover, post-dying, that is to say the dying of the textile layer after the bonding of the lining on it, corresponds to a desire for simplification in the garment manufacturing cycle, in that it makes it possible to dye the garment once made up according to the colour requested by the customer.

Heat-bonding linings are already known, of the type formed by a non-woven textile support on which a discontinuous layer comprising a hot-melt polymer has been applied. These linings have the advantage of having a limited manufacturing cost whilst possessing reinforcement and comfort properties which are satisfactory and open to change.

However, none of these known linings gives satisfaction when they are associated with a textile layer which must undergo post-dying treatment.

This is because, during conventional post-dying treatments, for example of the fixing and washing type, the known linings are not able to fix the dye in a satisfactory fashion, with regard to the textile support and/or the discontinuous layer.

The result is in particular a difference in colour shade in the garment between the parts which are provided with a lining and those which are not. This problem is all the more critical for garments which comprise lightweight textile layers.

The invention aims to remedy this drawback by proposing a heat-bonding lining which, whilst having optimum reinforcement and comfort properties, is able to be dyed satisfactorily during post-dying treatment.

To this end, and according to a first aspect, the invention proposes a heat-bonding lining of the type comprising a non-woven textile support which is obtained by heat-bonding a layer of at least one type of fibre, and a discontinuous layer comprising a hot-melt polymer which is disposed on at least one of the faces of the textile support, in which, in combination, the textile support comprises at least 70% fibres formed by a polymer material based on polyamide and the hot-melt polymer is formed from polyamide.

According to a second aspect, the invention proposes a textile complex comprising such a lining and, bonded to the said lining, a textile layer intended to be reinforced.

According to a third aspect, the invention proposes a method of manufacturing such a textile complex, in which, subsequent to the bonding of the lining to the textile layer, the textile complex is dyed.

Other objects and advantages of the invention will emerge during the following description.

The invention concerns a heat-bonding lining comprising a non-woven textile support and a discontinuous layer comprising a hot-melt polymer which is disposed on at least one of the faces of the textile support.

The textile support is obtained by the thermobinding of a layer of at least one type of fibre. To this end, for example two card webs can be formed with the type or types of fibre previously intimately mixed, the said webs being placed one on top of the other in order to form a layer which is then calendered at a temperature higher than the melting point of the fibres so as to provide its thermobinding. The thermobound layer is then cooled and can undergo finishing operations in order to be usable as a textile support for lining. In particular, according to the quantity of fibres used and the calendering conditions, it is possible to obtain a textile support with a weight per surface area required according to the application sought. For example, for reinforcing a textile layer for a blouse, the weight per surface area of the textile support can typically be 20 g/cm².

After the formation of the textile support, the discontinuous layer is applied to one face of the said support, notably by point coating techniques such as for example printing techniques amongst which can be cited the screen-printing techniques of printing single or double points of a dispersion of fine powders of hot-melt polymers in aqueous phase.

Thus, in the embodiment described, the lining comprises a non-woven textile support, on one face of which there is disposed a lattice of discrete points comprising the hot-melt polymer.

The lining can then be bonded, by means of the hot-melt layer, to a textile layer intended to be reinforced so as to form a textile complex adapted for the production of garments or pieces of garment. In particular, the textile layer can be the external fabric of the garment, the said garment being made up by associating textile complex for the parts requiring a reinforcement and fabric for the other parts.

The garment, and therefore the textile complex, is intended to be dyed subsequently to the banding of the lining to the textile layer, the said textile layer for example having no dying prior to the bonding.

The technique of dying the garment is for example of the fixing and washing type, that is to say the garment is immersed in a tank in which there is a solution of dye according to the colour to be obtained and the nature of the textile layer to be dyed, the said garment undergoing a temperature cycle for fixing the dye to the said layer. Next the garment is rinsed and then dried.

During a post-dying treatment the textile complex is therefore subjected to a chemical and temperature treatment which is relatively violent.

The applicant has carried Out intensive tests for finding a lining which firstly resists the post-dying treatments without undergoing any significant deterioration in its reinforcement and comfort properties, and secondly is able to be dyed in a satisfactory fashion during this treatment.

It has been found that a lining in which firstly the non-woven textile support is heat-bonded and comprises at least 70% fibres formed by a polymer material based on polyamide and secondly the hot-melt polymer is formed from polyamide, advantageously fulfils the two conditions mentioned above. In particular, the fibres can be formed from polyamide 6 and the hot-melt polymer can be a hot-melt copolyamide.

According to the invention, the textile support can, through the bonding method and the nature of the fibres used, be arranged so as to have a resilience (elasticity under curvature or flexion) adapted for use in the lining, this property being combined with the ability of the polyamide-based fibres to be dyed.

Concerning the discontinuous layer, it has the advantage of also being dyed during the post-dying treatment, whilst providing optimum mechanical cohesion of the layers forming the complex.

Thus it is possible to make up a garment using both a complex comprising the lining according to the invention for the parts needing to be reinforced and the textile layer for the other parts, the said garment then being able to undergo post-dying treatment without exhibiting colour shades due to the presence of the lining.

In a particular embodiment of the textile support, the web comprises two types of fibre which are intimately mixed, the fibres of the second type being able to be formed from polyester so as to improve the dimensional stability of the textile support.

For example, the web can comprise between 80% and 90% by weight polyamide-based fibres and between 20% and 10% by weight polyester-based fibres, the fibres forming the web having a count of between 1 and 3 denier.

In a particular example the lining comprises:

a textile support comprising:

85% by weight polyamide 6 fibres, the said fibres having a mean length of 40 mm and a count of 2.2 denier; and

15% by weight polyester fibres, the said fibres having a mean length of 38 nm and a count of 1.5 denier;

a discontinuous layer of points:

of density 17 Mesh;

comprising PLATAMID® H2513 PA 80 polymer (sold by ATOFINA), which is a hot-melt copolyamide.

And the weights per surface area respectively of the textile support and of the discontinuous layer are 25 g/cm² and 13 g/cm³ for a weight per surface area of lining of 38 g/cm².

The continuous layer therefore has a relatively low weight per surface area compared with the weights per surface area conventionally used, in particular when the hot-melt polymer is based on polyethylene, without impairing the mechanical strength of the bonding whilst improving the resilience of the lining. In particular, the discontinuous layer advantageously resists the post-dying treatment as well as the subsequent conditions of use, in particular maintenance, of the garment.

In addition, the bonding can be carried out at a temperature of between 130° C. and 150° and at a pressure of between 3 and 3.5 bar, which is also lower than the temperatures lying between 150° C. and 160° C. which are typically used for bonding linings of the prior art.

Moreover, it has been found that the textile support is able advantageously to accompany the dimensional variations in the complex which are caused during the post-dying treatment, whilst preserving good strength.

1. A heat-bonding lining of the type comprising a non-woven textile support which is obtained by heat-bonding a web of at least one type of fibre, and a discontinuous layer comprising a hot-melt polymer which is disposed on at least one of the faces of the textile support, the said lining being characterized in that, in combination, the textile support comprises at least 70% fibres formed from a polymer material based on polyamide and the hot-melt polymer is formed from polyamide.

2. A lining according to claim 1, characterised in that the fibres are formed from polyamide 6.

3. A lining according to claim 1 or 2, characterised in that the hot-melt polymer is a hot-melt copolyamide.

4. A lining according to any one of claims 1 to 3, characterised in that the web comprises two types of fibre which are intimately mixed.

5. A lining according to claim 4, characterized in that the fibres of the second type are formed from polyester.

6. A lining according to claim 5, characterised in that the web comprises between 80% and 90% by weight fibres based on polyamide and between 20% and 10% by weight fibres based on polyester.

7. A lining according to any one of claims 1 to 6, characterised in that the fibres forming the web have a count of between 1 and 3 denier.

8. A lining according to any one of claims 1 to 7, characterised in that the layer comprising a hot-melt polymer is produced in the form of discrete points.

9. A textile complex comprising a lining according to any one of claims 1 to 8 and, bonded to the said lining, a textile layer intended to be reinforced.

10. A complex according to claim 9, characterized in that the textile layer has no dye.

11. A method of manufacturing a textile complex according to claim 9 or 10, characterised in that, subsequently to the bonding of the lining to the textile layer, the textile complex is dyed.

12. A method according to claim 11, characterised in that the bonding is carried out at a temperature of between 130° C. and 150° C. and at a pressure of between 3 and 3.5 bar.

13. A method according to claim 11 or 12, characterised in that the dying of the textile complex is carried out by a technique of the fixing and washing type.
